(19) United States
(12) Patent Application Publication
(10) Pub. No.: US 2013/0283814 A1
(43) Pub. Date: Oct. 31, 2013

(54) TURBINE COOLING SYSTEM

(71) Applicants: David Richard Johns, Simpsonville, SC (US); Don Conrad Johnson, Simpsonville, SC (US)

(72) Inventors: David Richard Johns, Simpsonville, SC (US); Don Conrad Johnson, Simpsonville, SC (US)

(73) Assignee: GENERAL ELECTRIC COMPANY, Schenectady, NY (US)

(21) Appl. No.: 13/456,185

(22) Filed: Apr. 25, 2012

(51) Int. Cl. F02C 7/18; F02C 6/08

(52) U.S. Cl. 60/782; 60/806; 416/97 R

(57) ABSTRACT

A system includes a turbine. The turbine includes a rotor, a stator, and a cooling insert. The rotor includes multiple turbine blades. The stator surrounds the rotor and includes an inner wall surrounding the multiple turbine blades, an outer wall surrounding the inner wall, and a cooling chamber between the inner wall and the outer wall. The cooling insert extends through an opening in the outer wall into the cooling chamber. The insert includes a side wall extending around an axis, an end wall crosswise to the axis, a set of lateral ports extending through the side wall, and end ports extending through the end wall. The cooling insert is configured to direct a cooling fluid through the set of lateral ports and end ports into the cooling chamber.

### BACKGROUND OF THE INVENTION

The subject matter disclosed herein relates to gas turbine engines, and more specifically, to flow control assemblies for modulating the flow of cooling fluids to components of a gas turbine engine.

Gas turbine engines include a turbine having multiple blades attached to a central rotor. Hot combustion gases from a combustor flows through these blades, inducing the rotor to rotate. Minimizing the quantity of gas bypassing the blades enhances energy transfer from the gas flow to the turbine rotor. Under elevated temperatures of operation, gas turbine engine components, in particular rotating components in the gas path, may experience thermal expansion, stress, and wear. These components may be cooled by the flow of cooling fluids in and around the components. Unfortunately, a non-uniform distribution of these cooling fluids, and thus non-uniform cooling, may also lead to thermal stress due to temperature variations in the turbine components.

### BRIEF DESCRIPTION OF THE INVENTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In one embodiment, a system includes a turbine. The turbine includes a rotor, a stator, and a turbine cooling insert. The rotor includes multiple turbine blades. The stator surrounds the rotor and includes an inner wall surrounding the multiple turbine blades, an outer wall surrounding the inner wall, and a cooling chamber between the inner wall and the outer wall. The turbine cooling insert extends through an opening in the outer wall into the cooling chamber. The turbine cooling insert includes a side wall extending around an axis, an end wall extending crosswise to the axis, a set of lateral ports extending through the side wall, and end ports extending through the end wall. The turbine cooling insert is configured to direct a cooling fluid through the set of lateral ports and end ports into the cooling chamber.

In another embodiment, a system includes a turbine cooling insert. The cooling insert includes a side wall extending around an axis of the turbine cooling insert. The side wall includes a set of lateral ports extending through the side wall. The cooling insert also includes an end wall that extends crosswise to the axis of the cooling insert. The end wall includes a set of end ports extending through the end wall. The turbine cooling insert is configured to direct a cooling fluid through the set of lateral ports and the set of end ports into a cooling chamber of a hollow turbine casing.

In another embodiment, a method involves receiving a cooling fluid into a turbine cooling insert extending into a hollow turbine casing of a turbine. The method involves distributing the cooling fluid through multiple ports in the turbine cooling insert into a cooling chamber of the hollow turbine casing. The ports include a set of lateral ports disposed in a side wall of the turbine cooling insert and a set of end ports disposed in an end wall of the turbine cooling insert.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a block diagram of an embodiment of a turbine system that is equipped with one or more cooling inserts to improve distribution of a coolant (e.g., cooling air);

FIG. 2 is a partial cross-sectional side view of an embodiment of a turbine section, as shown in FIG. 1, illustrating a cooling insert;

FIG. 3 is a partial cross-sectional view of an embodiment of a turbine section, taken within line 3-3 of FIG. 2, illustrating a cooling insert

FIG. 4 is a perspective view of an embodiment of a cooling insert;

FIG. 5 is a partial cross-sectional side view of an embodiment of a cooling insert with angled end ports; and

FIG. 6 is a partial cross-sectional side view of an embodiment of a cooling insert with a curved end wall.

### DETAILED DESCRIPTION OF THE INVENTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions may be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

The disclosed embodiments include cooling inserts for metering and diffusing an internal flow of coolants (e.g., cooling fluids) to components of a gas turbine engine. During operation, a turbine engine generates hot combustion gases that are directed throughout parts of the engine. In the interest of engine efficiency, it is desirable to block leakage of these combustion gases and route the gases through one or more turbine stages to generate power. Accordingly, the stator components of the engine may be designed to withstand higher temperatures. However, even with temperature-resistant casings and other stator components, it may be advantageous to strategically direct cooling fluids to certain components of the engine to maintain desired operating temperatures. The disclosed cooling inserts are configured to distribute a coolant (e.g., compressed air flow) in multiple directions (e.g., axial, radial, and circumferential directions) to increase uniformity in cooling the turbine components. The disclosed cooling inserts may include a plurality of ports, e.g., approximately 2 to 1000, 10 to 500, or 20 to 100 ports, to meter, diffuse, and direct the coolant in a manner that maintains a more uniform temperature distribution in the turbine section.

Stator components of the engine may be assembled in segments in an axial direction, (e.g., segments assembled one after another along an axis of an engine's rotating shaft) and/or a circumferential direction, (e.g., segments assembled to substantially surround the shaft or other mechanical components). In either example, the segments may be assembled with a goal of encasing rotating and/or moveable components. In addition, the segments may surround rotating components that are aligned with respect to the stator components to maintain a desired minimal clearance to increase efficiency. The disclosed cooling inserts help increase uniformity in cooling the stator components, thereby helping to control thermal expansion (and clearance) of the stator components more uniformly around the rotating and/or moveable components.

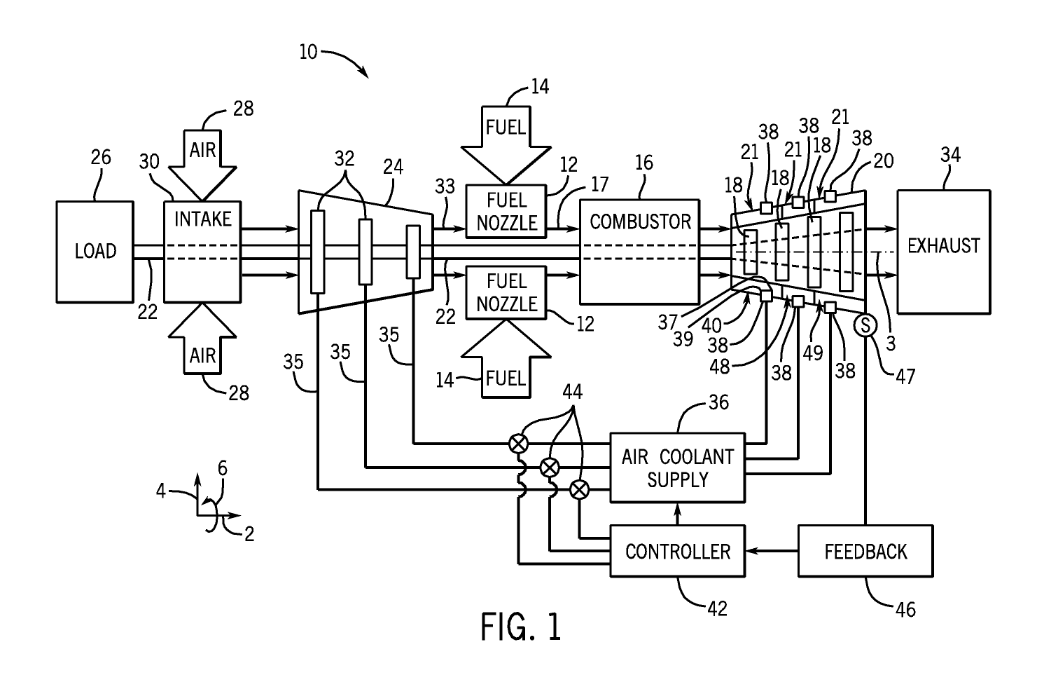

Turning now to the drawings and referring first to FIG. 1, a block diagram of an embodiment of a turbine system 10 (e.g., gas turbine engine) that is equipped with one or more cooling inserts 38 to improve distribution of a coolant (e.g., cooling air) is illustrated. As discussed previously, the cooling inserts 38 are configured to distribute a coolant in multiple directions to increase uniformity in cooling of turbine components. In the following discussion, reference may be made to an axial direction or axis 2 relative to a longitudinal axis 3, a radial direction or axis 4 away from the axis 3, and a circumferential direction 6 around the axis 3. As illustrated, the turbine system includes a fuel nozzle 12, a fuel supply 14, and a combustor 16. The fuel supply 14 routes a liquid fuel or gas fuel, such as natural gas, to the turbine system 10 through fuel nozzle 12 into combustor 16. After mixing with pressurized air, shown by arrow 17, ignition occurs in combustor 16 and the resultant exhaust gas causes blades 18 within turbine 20 (e.g., one or more turbine stages 21) to rotate. The coupling between the blades 18 in turbine 20 and shaft 22 causes rotation of shaft 22, which is also coupled to several components throughout the turbine system 10. For example, the illustrated shaft 22 is drivingly coupled to a compressor 24 and a load 26. As appreciated, load 26 may be any suitable device that may generate power via the rotational output of turbine system 10, such as a generator or a vehicle.

Air supply 28 may route air via conduits to air intake 30, which then routes the air into compressor 24. Compressor 24 includes a plurality of blades 32 drivingly coupled to shaft 22, thereby compressing air from air intake 30 and routing it to fuel nozzles 12 and combustor 16, as indicated by arrows 33. Fuel nozzle 12 may then mix the pressurized air and fuel, shown by numeral 17, at an optimal ratio for combustion, e.g., a combustion that causes the fuel to more completely burn so as not to waste fuel or cause excess emissions. After passing through turbine 20, the hot exhaust gases exit the system at exhaust outlet 34. The turbine system 10 includes a variety of components that move and/or rotate, such as the shaft 22, relative to other components that are stationary during operation of the system 10.

The turbine system 10 may include a system to cool the internals of turbine 20. As shown, a portion of air from compressor 24 (or another separate source) is routed to a cooling air supply 36 through fluid conduits 35 (e.g., extraction pipes). As illustrated, the air is routed through three fluid conduits 35 disposed at different stages of the compressor 24. In other embodiments, the air may be routed through 1, 2, 3, 4, 5, or more fluid conduits 35. The air in each stage of the compressor 24 may have a different temperature and/or pressure, and it may be desirable to use air with varying thermodynamic properties to cool the turbine 20. In certain embodiments, the supply 36 may include a heat exchanger (e.g., cooler) to cool the air for use in cooling the turbine 20. Air from the cooling air supply 36 is routed through one or more turbine cooling inserts 38 into one or more turbine cavities (e.g., cooling chambers 40). Each cooling insert 38 includes a perforated portion 37 (e.g., perforated end portion) with a plurality of cooling ports 39. The air cools the turbine internals, and exits the cooling chamber 40 through one or more outlets. For example, the cooling air may exit and join with the exhaust gases exiting through exhaust outlet 34.

In certain embodiments, the cooling chambers 40 are located at turbine stages 21, and these turbine stages 21 may have 4 cooling chambers 40. Some turbine stages 21 may not have cooling chamber 40, while other turbine stages 21 may have 1, 2, 3, 4, 5, or 6 or more cooling chambers 40. Thus, the number of cooling chambers 40 per turbine stage 21 may vary. Each cooling chamber 40 has at least one turbine cooling insert 38. As discussed below, the cooling insert 38 is configured to meter, diffuse and/or distribute the cooling air into the cooling chamber 40 to improve uniformity of cooling of the turbine 20. For example, each insert 38 may include a plurality of cooling ports 39 oriented in various directions to control the cooling air flow in a manner that provides a more uniform temperature distribution in the turbine 20. Thus, the air from cooling air supply 36 may be fed to multiple inserts 38 that cool different stages 21 of turbine 20. Additionally, the air may be fed to multiple inserts 38 that cool a common stage 21 of turbine 20. Furthermore, the air may be fed to multiple inserts 38 that cool a common cooling chamber 40 of a stage 21 of turbine 20. According to certain embodiments, cooling fluid may continuously flow from cooling air supply 36 to continuously cool turbine 20.

The cooling of turbine 20 may be regulated entirely by inserts 38 and/or other flow control devices. As may be appreciated, inserts 38 have a maximum flow rate that may flow through them, and certain embodiments of turbine system 10 may desire that the maximum flow rate continuously enters cooling chambers 40 while the turbine system 10 is operating. However, the turbine system 10 may also include a controller 42 to regulate the amount of cooling air that is routed to cooling chambers 40. Controller 42 may throttle valves 44 to increase or decrease the flow of cooling air for cooling of turbine 20 based on a feedback signal 46 from one or more sensors 47. For example, if a first cooling chamber 48 is overcooled and a second cooling chamber 49 is starved of cooling air, controller 42 may adjust valves 44, so that the overcooled cooling chamber 48 receives less cooling air and the starved cooling chamber 49 receives more cooling air. Accordingly, the temperature gradient across turbine 20 may decrease using the disclosed cooling inserts 38. Sensor 47 may measure the temperature of cooling chamber 40, or some other variable that is dependent upon adjusting valves 44.

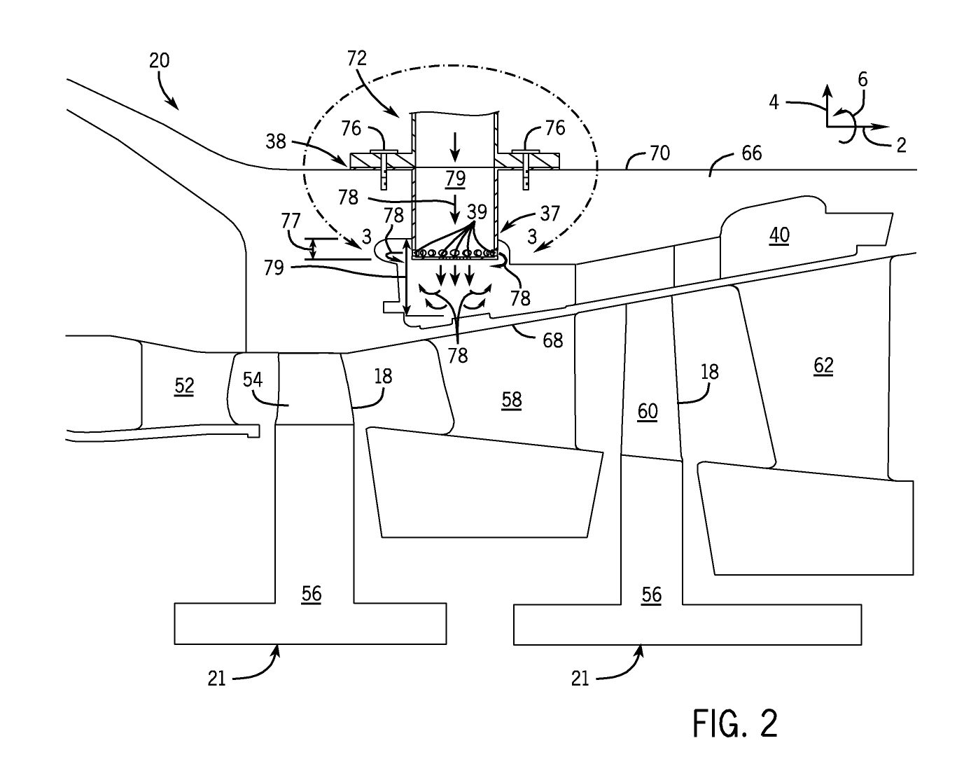

FIG. 2 is a partial cross-sectional side view of an embodiment of a section of turbine 20 illustrating the cooling inserts 38. As described previously, the cooling inserts 38 are configured to meter, diffuse and/or distribute the cooling air into the cooling chamber 40 in various directions to improve uniformity of cooling of the turbine 20. As illustrated in FIG. 2, hot gas from the combustor 16 flows into the turbine 20 in the axial direction 6. The turbine 20 illustrated in the present embodiment includes three turbine stages 21. Other embodiments of turbine 20 may include more or fewer turbine stages 21. For example, a turbine may include 1, 2, 3, 4, 5, 6, or more turbine stages 21. Each turbine stage 21 includes a plurality of nozzles (e.g., stationary blades) and a plurality of rotating buckets or blades 18. The first turbine stage 21 includes nozzles 52 and blades 54 substantially equally spaced in the circumferential direction 6 about the axis 3 of the turbine 20. The first stage nozzles 52 are rigidly mounted to turbine 20 and configured to direct combustion gases toward the blades 54. The first stage blades 54 are mounted to a rotor 56 that rotates as combustion gases flow through the blades 54. The rotor 56 is, in turn, coupled to the shaft 22, which drives compressor 24 and load 26 (see FIG. 1). The combustion gases then flow through second stage nozzles 58 and second stage blades 60. The second stage blades 60 are also coupled to rotor 56. Finally, the combustion gases flow through third stage nozzles 62 and blades 64. In other embodiments, the number of turbine stages 21 of the turbine 20 may vary (e.g., approximately 1 to 20, 2 to 10, or 3 to 5 turbine stages 21). As the combustion gases flow through each stage, energy from the combustion gases is converted into rotational energy of the rotor 56. After passing through each turbine stage 21, the combustion gases exit the turbine 20 in the axial direction 2 and/or radial direction 4.

Rotor 56, which includes blades 54, 60, and 64, is surrounded by stator components, including a hollow turbine casing 66. Casing 66 includes an inner wall 68 that surrounds blades 54, 60, and 64 and an outer wall 70 that surrounds inner wall 68. Cooling chamber 40 is housed within casing 66 between outer wall 70 and inner wall 68. Casing 66 may be made from materials capable of withstanding high temperatures. A cooling fluid conduit 72 delivers cooling fluid from the cooling air supply 36 (FIG. 1) to cooling chamber 40 through an opening 74 in outer wall 70. Insert 38 is coupled to conduit 72 and outer wall 70, and insert 38 extends through opening 74 into chamber 40. Insert 38 may be coupled to conduit 72 and outer surface 70 with fasteners 76. For example, insert 38 may be coupled to conduit 72 with bolts, welds, braze, or another suitable attachment mechanism. Cooling fluid flows from conduit 72 into insert 38, and insert 38 distributes the cooling fluid throughout cooling chamber 40. Flow arrows 78 illustrate a possible path for the cooling fluid as it fills cooling chamber 40. The cooling fluid may exit cooling chamber 40 through outlets, which may route the heated cooling fluid into the turbine exhaust 34. As illustrated, the insert 38 extends radially 4 through the outer wall 70, and partially protrudes into the chamber 40. Again, each chamber 40 may have approximately 1 to 100 inserts 38 to meter, diffuse, and distribute the cooling fluid flow 78 throughout the chamber 40. Each insert 38 includes the perforated end portion 37 with the plurality of cooling ports 39 oriented in various directions (e.g., axial 2, radial 4, and/or circumferential 6) to ensure flow of the cooling fluid to various hot spots and/or critical regions in the chamber 40. The cooling ports 39 may also have a variety of sizes to control the distribution and velocity of the cooling fluid flow into the chamber 40. As further illustrated, the inserts 38 may extend into the chamber 40 to a radial depth 77 away from the outer wall 70, thereby orienting the cooling ports 39 in more suitable locations to enhance cooling. In certain embodiments, the radial depth 77 may be approximately 0 to 95, 1 to 75, 2 to 50, 3 to 25, or 4 to 15 percent of a radial distance 79 between the inner and outer walls 68 and 70. Specific details of the insert 38 are discussed in further detail below.

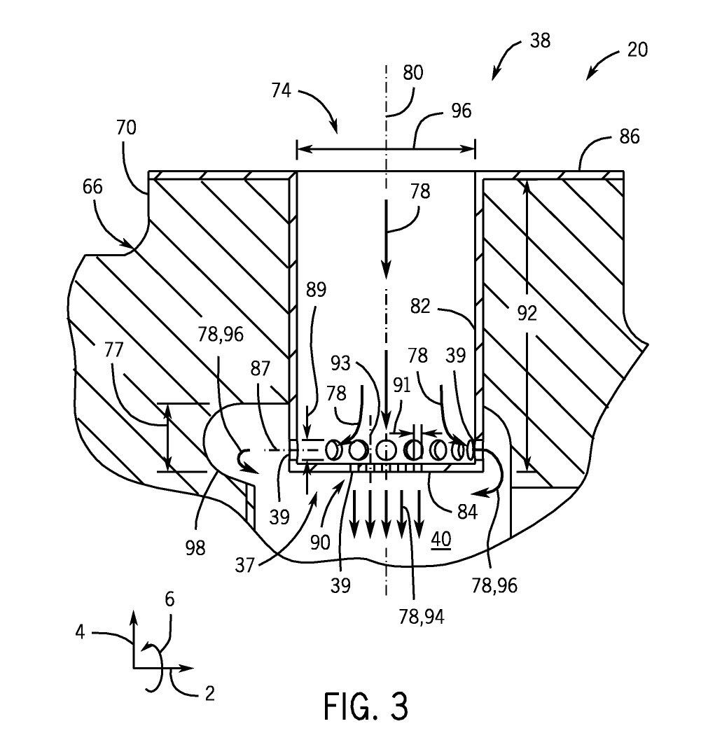

FIG. 3 is a partial cross-sectional view of an embodiment of the turbine 20 taken within line 3-3 of FIG. 2, illustrating the cooling insert 38. The insert 38 extends through the opening 74 in outer wall 70 and into cooling chamber 40. Insert 38 is oriented about an axis 80, which is crosswise to outer wall 70. Insert 38 includes a side wall 82 (e.g., hollow annular wall) that extends around axis 80, an end wall 84 that extends crosswise to axis 80, and a mounting end or flange 86. Mounting end 86 is configured to mount with the outer wall 70 of the turbine casing 66 via a welded joint, a brazed joint, bolts, or other fasteners. As discussed above, the insert 38 includes the perforated portion 37 with multiple cooling ports 39. In the illustrated embodiment, the perforated portion 37 includes ports 39 in both the side wall 82 and the end wall 84. A set of lateral ports 39, 88 extends through side wall 82. Each lateral port 88 has an axis 87 and a width or diameter 89. A set of end ports 90 extends through end wall 84. Each end port 90 has a width or diameter 91 and an axis 93.

According to certain embodiments, the diameter 89, 91 and the axis 87, 93 of each port 39 (e.g., 88, 90) may vary to achieve a controlled and/or uniform distribution of cooling fluid in cooling chamber 40. For example, the ratio of the diameter 89 of the lateral ports 88 to the diameter 91 of the end ports 90 may be greater than or equal to approximately 20:1, 15:1, 10:1, 5:1, 4:1, 3:1, 2:1, or 1:1. Alternatively, the ratio of the diameter 91 of the end ports 90 to the diameter 89 of the lateral ports 88 may be greater than or equal to approximately 20:1, 15:1, 10:1, 5:1, 4:1, 3:1, 2:1, or 1:1. In other words, the diameter 89 may be greater than the diameter 91 by some factor, or vice versa. Further, the size of the diameters 89, 91 may be relative to an inside diameter 95 of the insert 38. For example, the ratio of the diameter 89 of the lateral ports 88 to the inside diameter 95 of the insert 38 may be less than or equal to approximately 1:20, 1:15, 1:10, 1:5, or 1:2. Similarly, the ratio of the diameter 91 of the end ports 90 to the inside diameter 95 of the insert 38 may be less than or equal to approximately 1:20, 1:15, 1:10, 1:5, or 1:2. In other words, the diameters 89, 91 of the ports 88, 90 may be less than the diameter 95 of the insert 38 by some factor.

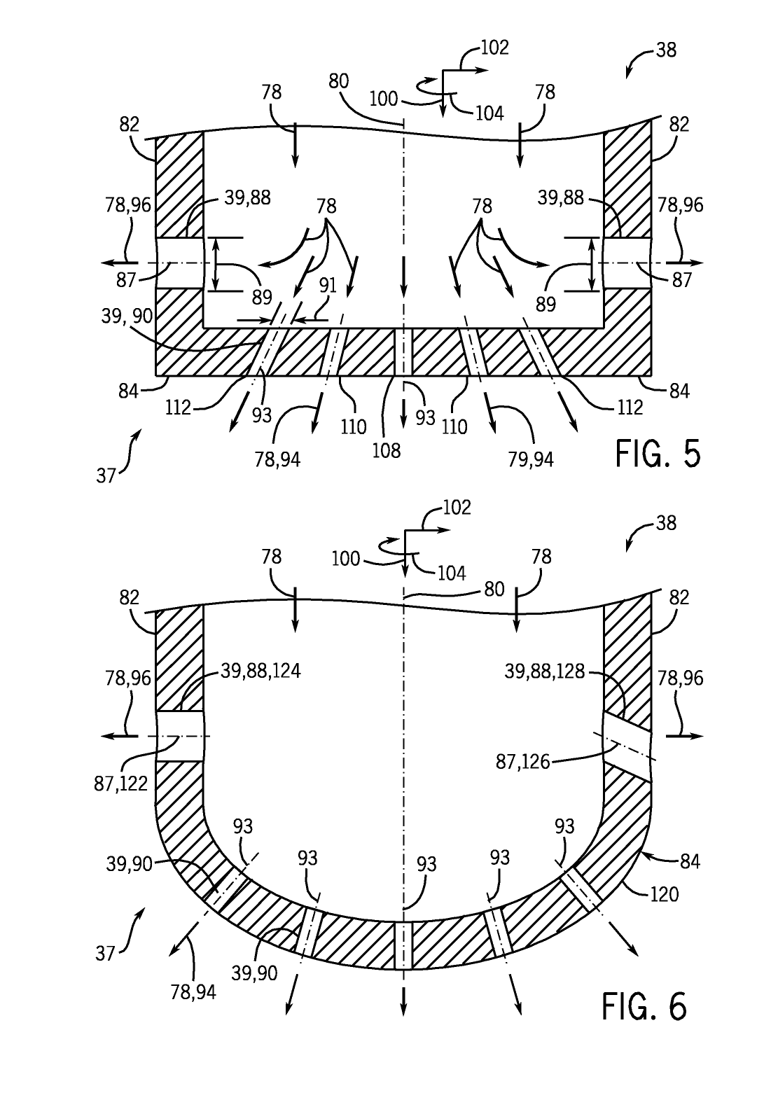

As illustrated in FIG. 3, the axis 87 of the lateral ports 88 is perpendicular to the axis 80 of the cooling insert 38. Additionally, the axis 93 of the end ports 90 is parallel to the axis 80 of the cooling insert 38. In other embodiments, and as further illustrated in FIGS. 5 and 6, the axes 87, 93 of the ports 88, 90 may form different angles with the axis 80 of the cooling insert 38. For example, the angles that the axes 87, 93 form with the axis 80 may be approximately 0 to 90, 10 to 80, 20 to 70, 30 to 60, or 40 to 50 degrees. As may be appreciated, the various angles that the axes 87, 93 form with the axis 80 may affect the distribution of cooling fluid in the cooling chamber 40. Additionally, the shape of each port 39 (e.g., 88, 90) may vary. For example, the ports 39 may have a circular, square, conical, or another suitable shape. Thus, the desired diameter, orientation of axes, and shape of each port 39 (e.g., 88, 90) may vary. Because each cooling chamber 40 within the turbine 20 may have a different shape, each insert 38 may have a different design to accommodate the cooling chambers 40. Insert 38 has an insertion depth 92 radially 4 into the turbine casing 66, which controls the radial depth 77 as discussed above. In certain embodiments, the insertion depth 92 (and radial depth 77) may vary to allow different degrees of cooling fluid penetration into cooling chamber 40. Similarly, lateral ports 88 may be located at different axial positions along axis 80 on side wall 82 to achieve a different distribution of cooling fluid into cooling chamber 40.

A cooling fluid, such as compressed air, enters the opening 74 and flows along axis 80 through insert 38, as indicated by cooling flow path 78. When the cooling fluid flow 78 reaches perforated portion 37, insert 38 directs a portion of the cooling fluid flow 78 through end ports 39, 90 into cooling chamber 40 along flow paths 78, 94. Insert 38 directs another portion of the cooling fluid flow 78 through lateral ports 39, 88 into cooling chamber 40 along flow paths 96. A LF:EF ratio (i.e., lateral flow (LF) to end flow (EF) ratio) of the cooling fluid flow 78 through the lateral ports 88 relative to the fluid flow through end ports 90 affects the distribution of the fluid in cooling chamber 40. As discussed previously, in certain embodiments, the insert 38 has an LF:EF ratio of greater than approximately 1:1 (e.g., the portion of fluid flowing through lateral ports 88 is greater than the portion of fluid the flowing through end ports 90). In some embodiments, the LF:EF ratio of the cooling insert 38 is greater than approximately 3:1, 4:1, 5:1, 6:1, 7:1, 8:1, 9:1, or 10:1, or between approximately 2:1 to 20:1, 5:1 to 15:1, or 8:1 to 12:1. However, the LF:EF ratio may be adjusted based on various cooling goals for the particular chamber 40.

The lateral ports 88 and end ports 90 enable insert 38 to meter, diffuse, and distribute the cooling fluid flow 78 in a controlled manner into the chamber 40. Furthermore, when cooling fluid is fed through multiple discrete openings 74 without inserts 38 in the outer wall 70, the cooling fluid may enter each cooling chamber 40 at a different rate without the inserts 38. Certain chambers 40 may be starved of cooling fluid while other chambers 40 are overcooled. The perforated portions 37 (e.g., multiple cooling ports 39) of the inserts 38 help to reduce the variation of cooling fluid flow 78 among the cooling chambers 40. Certain embodiments may use multiple inserts 38 with ports 39 (e.g., 88, 90) of differing diameters, orientation of axes, and/or shapes to control the cooling flow 78 in other ways (e.g., more flow or less flow as needed).

Additionally, insert 38 improves the distribution of the cooling fluid flow 78 within cooling chamber 40 by forcing the cooling fluid flow 78 to split into multiple directions (e.g., partially through the lateral ports 88 and partially through the end ports 90). In the absence of lateral ports 88, region 98 may receive little cooling, as the cooling fluid exiting through end ports 90 preferentially continues to flow toward the inner wall 68. Thus, the inserts 38 provide an improved diffusion and distribution of cooling fluid within cooling chamber 40, thereby providing a more uniform and controlled cooling of turbine casing 66. Inserts 38 may be employed with an existing turbine system 10 to convey the aforementioned features by retrofitting an insert 38 into each opening 74 in outer wall 70.

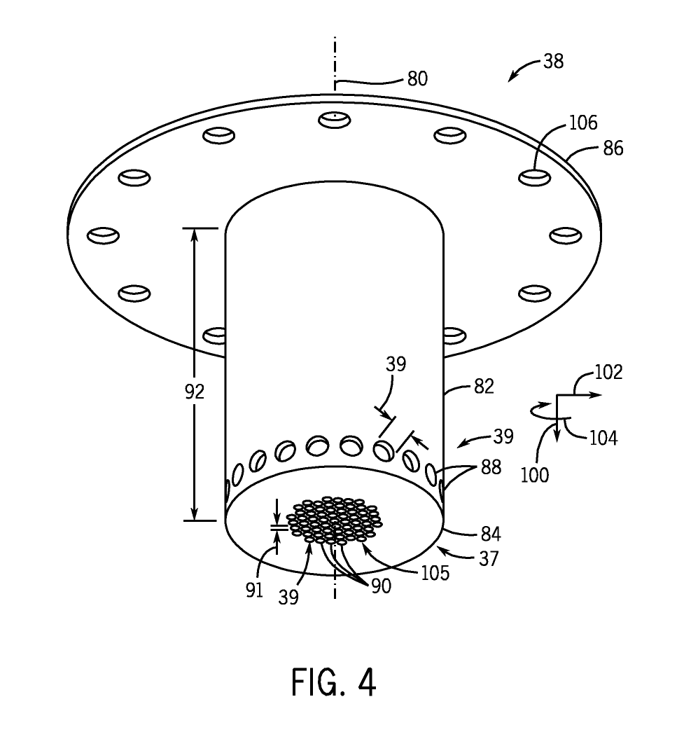

FIG. 4 is a perspective view of an embodiment of the cooling insert 38. As shown, insert 38 has an annular shape defined by the side wall 82 (e.g., annular side wall), the end wall 84 (e.g., flat end wall), and the mounting end 86. With reference to axis 80 of the insert 38, the shape and configuration of the insert 38 may be described with reference to an axial direction 100, a radial direction 102, and a circumferential direction 104. Side wall 82 is disposed circumferentially 104 about axis 80, while end wall 84 extends crosswise or radial 102 (e.g., perpendicular) to axis 80. According to other embodiments, insert 38 may have a conical tubular shape, a polyhedral tubular shape, a square or rectangular tubular shape, or any other shape suitable for delivering a cooling fluid to cooling chamber 40. As shown, cooling ports 39 have a circular shape, although the ports 39 may be shaped as an oval, square triangle, chevron, X, T, V, I, or any combination thereof. The lateral ports 88 are oriented in the radial direction 102 relative to axis 80, while end ports 90 are oriented in the axial direction 100 relative to axis 80. Thus, the lateral ports 88 and end ports 90 may be oriented at different angles relative to axis 80. As discussed previously, the angle formed by the lateral ports 88 relative to the axis 80 may be approximately 0 to 90, 10 to 80, 20 to 70, 30 to 60, or 40 to 50 degrees. Similarly, the angle formed by the end ports 90 relative to the axis 80 may be approximately 0 to 90, 10 to 80, 20 to 70, 30 to 60, or 40 to 50 degrees. The angles formed by the lateral ports 88 relative to the axis 80 may be the same or different from the angles formed by the end ports 90 relative to the axis 80.

As illustrated, the diameter 89 of the lateral ports 88 is larger than the diameter 91 of the end ports 90. As discussed previously, the ratio of the diameter 89 of the lateral ports 88 to the diameter 91 of the end ports 90 may be greater than or equal to approximately 20:1, 15:1, 10:1, 5:1, 4:1, 3:1, 2:1, or 1:1. Further, the ports 39 may include any number of lateral ports 88 (e.g., 1 to 50) and end ports 90 (e.g., 1 to 100). For example, insert 38 may include approximately 5 to 50, 10 to 40, or 20 to 30 lateral ports 88, and approximately 1 to 200, 25 to 100, or 50 to 75 end ports 90. As shown, lateral ports 88 share a common axial 100 position on side wall 82 along axis 80. However, the lateral ports 88 may be placed in a different arrangement on side wall 82, such that ports 88 occupy one or more different axial 100 positions (e.g., 2, 3, 4, 5, or more) on side wall 82 along axis 80. End ports 90 are disposed about a central region 105 of end wall 84. However, the end ports 90 may also be disposed about the circumference of end wall 84, scattered randomly about end wall 84, or exhibit another suitable arrangement for directing cooling fluid in an axial 100 direction relative to axis 80. As shown, mounting end 86 includes circumferentially spaced holes 106 to accept the fasteners 76 for mounting the insert 38 to outer wall 70. As discussed previously, in some embodiments, conduit 62, insert 38, and outer wall 70 may be coupled with one or more welded joints, brazed joints, or other fastening mechanisms.

FIG. 5 is a partial cross-sectional side view of an embodiment of cooling insert 38 with angled end ports 90. Insert 38 has the side wall 82 extending circumferentially 104 about axis 80, and the end wall 84 extending crosswise or radial 102 (e.g., perpendicular) to axis 80. Lateral ports 88 extend radially 102 through side wall 82, while the end ports 90 extend through end wall 84 with different angles relative to axis 80. Angled end ports 90 may enable the cooling fluid flow 78 to fill the cooling chamber 40 more uniformly. Cooling fluid enters insert 38 and flows along path 78. A portion of the cooling fluid flow 78 takes path 96 and exits insert 38 through lateral ports 88. Another portion of the cooling fluid flow 78 takes path 94 and exits insert 38 through angled end ports 90.

In the illustrated embodiment, the axes 87 of lateral ports 88 are crosswise (e.g., perpendicular) to the axis 80 of the insert 38, while the axes 93 of end ports 90 are parallel and/or angled relative to the axis 80. As discussed previously, axes 87 of lateral ports 88 may be angled between approximately 30 to 90 degrees, or approximately 30, 45, 60, or 90 degrees relative to axis 80. By further example, axes 93 of end ports 90 may be angled between approximately 0 to 75, 10 to 60, 20 to 50, 30 to 40, or approximately 45 degrees relative to axis 80. In some embodiments, the axis 93 of each port 90 may have a common angle (e.g., 15, 30, 45, 60, 75, or 90 degrees) relative to axis 80. In other embodiments, as illustrated, the axis 93 of each port 90 may be variably angled relative to the axis 80, such that the angle progressively changes (e.g., increases or decreases) with radial 102 distance from the axis 80. As illustrated, a central end port 90 (e.g., 108) may be parallel to the axis 80, a first set of surrounding end ports 90 (e.g., 110) may be angled at a first angle relative to axis 80, and a second set of surrounding end ports 90 (e.g, 112) may be angled at a second angle relative to axis 80. For example the first angle may be approximately 10 to 30 degrees, and the second angle may be approximately 40 to 60 degrees. As appreciated, any number of end ports 90 may progressively change angles (e.g., 1 to 20 angles) along the end wall 84. The angles of the lateral ports 80 and end ports 90 may be selected to improve the spread or distribution of cooling fluid flow 78 in the chamber 40. In some embodiments, the ports 39 may be angled about the axis 80 to impart a swirling flow. For example, angled end ports 90 may be angled to impart a swirling motion to the cooling fluid flow 78. In addition, the lateral ports 88 and end ports 90 may impart a swirling motion in the same or different directions. For example, the lateral ports 88 may impart a clockwise swirling motion while the end ports 90 may impart a counterclockwise swirling motion, or vice versa.

FIG. 6 is a partial cross-sectional side view of an embodiment of the cooling insert 38 with a curved end wall 120. Insert 38 has the side wall 82 extending circumferentially 104 about axis 80, and the end wall 84 extending crosswise to axis 80. As shown, the curved end wall 120 is convex. However, the curved end wall 120 may be concave, hemispherical, a quadric surface, or any suitable curved shape to deliver cooling fluid to cooling chamber 40. Lateral ports 88 extend radially 102 through side wall 82, and end ports 90 extend through curved end wall 120 at various angles relative to axis 80. End ports 90 may be orthogonal to curved end wall 120, parallel to axis 80, angled relative to axis 80, or arranged in other suitable orientations. As discussed previously, axes 87 of lateral ports 88 may be angled between approximately 30 to 90 degrees, or approximately 30, 45, 60, or 90 degrees relative to axis 80. As shown, the axis 87, 122 of the lateral port 88, 124 is angled at approximately 90 degrees relative to axis 80. Additionally, the axis 87, 126 of the lateral port 88, 128 is angled at approximately 45, 60, or 75 degrees relative to axis 80. Thus, the lateral ports 88 (124 and 128) may be angled differently from one another to control the distribution of cooling air into the chamber 40. By further example, axes 93 of end ports 90 may be angled between approximately 0 to 75, 10 to 60, 20 to 50, 30 to 40, or approximately 45 degrees relative to axis 80. In some embodiments, the axis 93 of each port 90 may have a common angle (e.g., 15, 30, 45, 60, 75, or 90 degrees) relative to axis 80. In other embodiments, as illustrated, the axis 93 of each port 90 may be variably angled relative to the axis 80, such that the angle progressively changes (e.g., increases or decreases) with radial 102 distance from the axis 80. For example, each port 90 may be perpendicular to the end wall 120, such that the curvature of the end wall 120 controls the angle of the port 90 relative to the axis 80. The non-flat (e.g., curved) shape of the end wall 120 also provides more surface area, which may be used to add more end ports 90.

As may be appreciated, the curved end wall 120 may allow cooling fluid to fill cooling chamber 40 more uniformly. Cooling fluid enters insert 38 and flows along path 78. A portion of the cooling fluid flow 78 takes path 96 and exits insert 38 through lateral ports 88. Another portion of the cooling fluid flow 78 takes path 94 and exits insert 38 through end ports 90. End ports 90 may be angled to impart a swirling motion to the cooling fluid about axis 80. For example, angled end ports 90 may be angled to impart a swirling motion to the cooling fluid flow 78. In addition, the lateral ports 88 and end ports 90 may impart a swirling motion in the same or different directions. For example, the lateral ports 88 may impart a clockwise swirling motion while the end ports 90 may impart a counterclockwise swirling motion, or vice versa.

Technical effects of the disclosed embodiments include a turbine cooling insert to improve cooling fluid distribution within a cooling chamber located in a turbine casing. The turbine cooling insert includes lateral ports and end ports that direct the cooling fluid into the cooling chamber. The turbine cooling insert provides flow control and diffusion of the cooling fluid, so that variation of flow is lessened among the various cooling chambers in the turbine casing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A system, comprising:
a turbine, comprising:
a rotor comprising a plurality of turbine blades;
a stator surrounding the rotor, wherein the stator comprises an inner wall surrounding the plurality of turbine blades, an outer wall surrounding the inner wall, and a first cooling chamber between the inner wall and the outer wall; and
a first turbine cooling insert extending through a first opening in the outer wall into the first cooling chamber, wherein the first turbine cooling insert comprises a first side wall extending around a first axis, a first end wall extending crosswise to the first axis, a first set of lateral ports extending through the first side wall, and a first set of end ports extending through the first end wall, wherein the first turbine cooling insert is configured to direct a first cooling fluid through the first set of lateral ports and the first set of end ports into the first cooling chamber.

2. The system of claim 1, wherein the first turbine cooling insert is configured to direct a first portion of the first cooling fluid through the first set of lateral ports and a second portion of the first cooling fluid through the first set of end ports into the first cooling chamber, and the first portion is greater than the second portion.

3. The system of claim 2, wherein a ratio of the first portion relative to the second portion of the first cooling fluid is greater than or equal to approximately 2:1.

4. The system of claim 2, wherein a ratio of the first portion relative to the second portion of the first cooling fluid is between approximately 5:1 and approximately 15:1.

5. The system of claim 1, wherein each lateral port of the first set of lateral ports has a first width, each end port of the first set of end ports has a second width, and the first width is greater than the second width.

6. The system of claim 1, wherein the first side wall comprises an annular side wall, the first end wall comprises a flat end wall, each lateral port of the first set of lateral ports is oriented in a radial direction relative to the first axis, and each end port of the first set of end ports is oriented in an axial direction relative to the first axis.

7. The system of claim 1, wherein the first end wall comprises a curved end wall.

8. The system of claim 1, wherein the first set of end ports comprise a plurality of differently angled end ports having different angles relative to the first axis.

9. The system of claim 1, comprising an air cooling supply coupled to the first turbine cooling insert.

10. The system of claim 1, comprising a second turbine cooling insert extending through a second opening in the outer wall into a second cooling chamber, wherein the second turbine cooling insert comprises a second side wall extending around a second axis, a second end wall extending crosswise to the second axis, a second set of lateral ports extending through the second side wall, and a second set of end ports extending through the second end wall, wherein the second turbine cooling insert is configured to direct a second cooling fluid through the second set of lateral ports and the second set of end ports into the second cooling chamber.

11. The system of claim 10, wherein the first and second turbine cooling inserts are disposed in different stages of the turbine.

12. The system of claim 10, wherein the first and second turbine cooling inserts are disposed in a common stage of the turbine.

13. The system of claim 10, comprising a first fluid conduit configured to supply the first cooling fluid to the first turbine cooling insert and a second fluid conduit configured to supply the second cooling fluid to the second turbine cooling insert.

14. The system of claim 1, comprising a turbine system having the turbine coupled to at least one of a compressor, a combustor, a generator, or a combination thereof

15. A system, comprising:
a turbine cooling insert, comprising:
a side wall extending around an axis of the turbine cooling insert, wherein the side wall comprises a set of lateral ports extending through the side wall;
an end wall extending crosswise to the axis, wherein the end wall comprises a set of end ports extending through the end wall, wherein the turbine cooling insert is configured to direct a cooling fluid through the set of lateral ports and the set of end ports into a cooling chamber of a hollow turbine casing.

16. The system of claim 15, comprising a gas turbine engine having the turbine cooling insert.

17. The system of claim 15, wherein the turbine cooling insert is configured to direct a first portion of the cooling fluid through the set of lateral ports and a second portion of the cooling fluid through the set of end ports into the cooling chamber, and the first portion is greater than the second portion.

18. The system of claim 17, wherein a ratio of the first portion relative to the second portion of the first cooling fluid is between approximately 2:1 and approximately 20:1.

19. A method, comprising:
receiving a cooling fluid into a turbine cooling insert extending into a hollow turbine casing of a turbine; and
distributing the cooling fluid through a plurality of ports in the turbine cooling insert into a cooling chamber of the hollow turbine casing, wherein the plurality of ports comprises a set of lateral ports disposed in a side wall of the turbine cooling insert, and the plurality of ports comprises a set of end ports disposed in an end wall of the turbine cooling insert.

20. The method of claim 19, wherein distributing the cooling fluid comprises:
directing a first portion of the cooling fluid through the set of lateral ports; and
directing a second portion of the cooling fluid through the set of end ports, wherein the first portion is greater than the second portion.
